(19) United States
(12) Patent Application Publication
(10) Pub. No.: US 2018/0184828 A1
(43) Pub. Date: Jul. 5, 2018

(54) FILTERED DRINKING STRAW

(71) Applicants: Robert HODGINS, Shawville (CA); Donna ANDREW, Shawville (CA)

(72) Inventors: Robert HODGINS, Shawville (CA); Donna ANDREW, Shawville (CA)

(21) Appl. No.: 15/741,004

(22) PCT Filed: May 11, 2016
(86) PCT No.: PCT/CA2016/000134

§ 371 Date: Dec. 29, 2017

(30) Foreign Application Priority Data
Jun. 30, 2015 (CA) 2895951

(51) Int. Cl. A47G 21/18; C02F 1/28; B01D 15/00; C02F 1/467; B01J 20/20; B01J 20/28

(52) U.S. Cl. CPC A47G 21/188; A47G 21/185; C02F 1/283; B01D 15/00; C02F 2101/38; B01J 20/20; B01J 20/28016; C02F 2303/02; C02F 1/467

(57) ABSTRACT

A filtered drinking straw for reducing the amount of impurities in an aqueous solution and method for using same. The straw comprises a tube having a passageway containing filtering medium and plugs positioned in the tube to keep the filter medium in the straw. The plugs permit passage of the aqueous solution therethrough but not the passage of the filter medium. A first filter medium comprises granular, activated carbon (GAC) and/or bone char to deodorize and absorb impurities, especially organic matter including nitrates and fluoride. The second filter medium is preferably in the form of fine metal strands formed into a batting. Such strands may be spun or woven from high purity zinc and copper alloy. The first plug is a standard plain plug comprising polyolefin plastics such as polyethylene and polypropylene. The second plug is a carbon plug which could be impregnated with silver. The third plug is made with bactericidal, virucidal and fungicidal material.

### FIELD OF THE INVENTION

The present invention relates to filtering systems for aqueous solutions and more particularly to filtering systems contained within a drinking straw.

### BACKGROUND OF THE INVENTION

Portable filtering systems such as U.S. Pat. No. 4,298,475 to Gartner are known which provide an elongate tube through which water is to be drawn in the manner of a straw. Such filtering systems suffer a number of disadvantages. Firstly, they typically require very strong suction to draw water through them with the result that they are only really suitable for emergency use and cannot conveniently be used to drink fluids. Secondly, the tubes are of a relatively complex structure and are difficult to manufacture.

Applicant's previous filtering system U.S. Pat. No. 5,156,335 required the use of plugs to separate the filtering media. These plugs were required to be heated to above room temperature, inserted when hot, and compressed and then released. This required complex and expensive machinery.

A thick-walled straw was used to provide stability and to enable the plugs to be forcefully inserted. One difficulty with thick-walled straws is that they therefore reduce the water flow and require greater effort on the part of the person drinking.

Advances in filtering technology have resulted in more efficient ways to remove impurities. Since 2003, for example, plugs can now be made with bactericidal, virucidal and fungicidal material.

It would be advantageous to provide a simpler filtered drinking straw which would take advantage of these advances in technology.

### SUMMARY OF THE INVENTION

Accordingly, to at least partially overcome the disadvantages of the prior art, the present invention provides a drinking straw with a simplified construction in which plugs to retain filter media in the straw are inserted at room temperature and retained in force fit relation within the tube.

The present invention comprises a drinking straw for filtering an aqueous solution containing impurities and delivering the filtered solution to a person's mouth. The drinking straw comprises a tube having a first end and a second end with a first passageway therethrough. The tube is sufficiently sized so that the second end of the tube contacts the aqueous solution and the first end is receivable in the person's mouth.

A sufficient amount of one or more filter medium is disposed in the first passageway. The filter medium is capable of permitting the passage of the solution through the first passageway while reducing the amount of impurities including bacteria in the solution that passes through the tube. A first filter medium comprises granular, activated carbon (GAC) and/or bone char to deodorize and absorb impurities, especially organic matter including nitrates and fluoride. Preferably, the carbon is acid washed to remove acid soluble ash from the carbon. The addition of bone char has been found to be particularly effective because it reduces fluoride.

In a preferred embodiment, the second filter medium is preferably in the form of fine metal strands formed into a batting. Such strands may be spun or woven from high purity zinc and copper alloy.

At least two plugs are positioned in the first passageway such that the filter medium is retained in a selected area of the first passageway between the plugs. The plugs are capable of permitting the passage of the aqueous solution through the plugs but will not permit the passage of the filter medium through the plugs. Preferably, a first plug is a standard plain plug comprising polyolefin plastics such as polyethylene and polypropylene. Preferably a second plug is a carbon plug which could be impregnated with silver. Preferably a third plug is made with bactericidal, virucidal and fungicidal material.

The present invention also comprises a method for reducing impurities in an aqueous solution containing impurities consumed by a person. The second end of the above described drinking straw is placed in the solution and the first end is sucked to draw the solution through the tube and into the person's mouth.

### BRIEF DESCRIPTION OF THE DRAWINGS

FIG. 1 is an elevational view of a preferred embodiment of the present invention;

FIG. 2 is a cross-sectional view of the apparatus shown in FIG. 1 taken along lines A-A;

FIG. 3 is a cross-sectional view of the apparatus shown in FIG. 1 along line B-B;

FIG. 4 is a bottom end view of the apparatus shown in FIG. 1;

FIG. 5 is a top plan view of the apparatus shown in FIG. 1;

FIG. 6 is a cross-sectional view of the apparatus shown in FIG. 1 along line C-C;

### DETAILED DESCRIPTION OF THE PREFERRED EMBODIMENTS

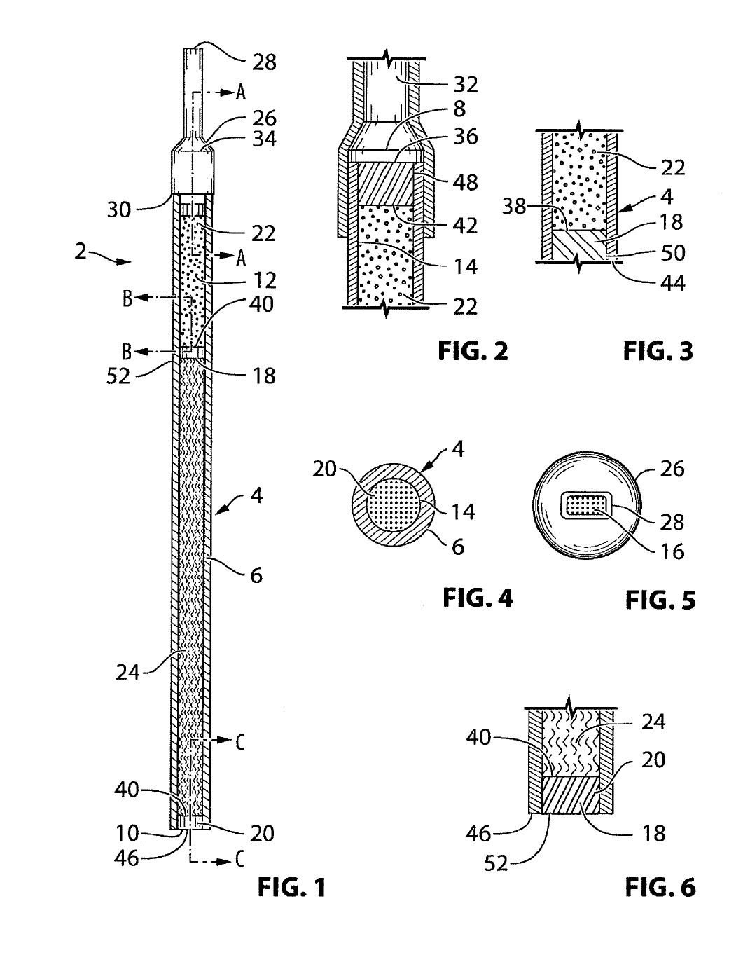

Referring to FIG. 1 and FIG. 2, the drinking straw 2 comprises a tube 4 having an outer periphery 6, a first end 8 and a second end 10 with a first passageway 12 therethrough defining an interior wall 14; three plugs 16, 18 and 20 positioned in the first passageway 12; and a first filter medium 22 disposed between plugs 16 and 18 and a second filter medium 24 disposed between plugs 18 and 20.

The tube 4 may be of any length or configuration suitable for the purpose of the present invention as stated herein. Generally, a linear tube of about seven inches from the first end 8 to the second end 10 is sufficient. Another embodiment of the present invention (not shown), angles about the upper third of the tube about twenty to forty degrees in order to facilitate drinking from the straw when the straw is positioned in a glass or other container.

While the tube 4 is preferably of a generally circular shape, it could also be of an oval shape, or any configuration which permits the passage of a liquid therethrough.

The tube 4 may be of any diameter suited for the purpose of the present invention. Preferably the tube 4 has a consistent diameter from the first end 8 to the second end 10. The second end 10 contacts the solution which is preferably in a container such as a glass or water bottle. Therefore it is preferable that the second end 10 of the tube 4 is capable of fitting into a container such as a water bottle. Preferably, the tube 4 has a consistent diameter of about 10 mm.

The tube 4 has the first passageway 12 from the first end 8 of the tube 4 to the second end 10 of the tube 4, whereby a solution received by the second end 10 of the tube may pass through the first passageway 12 to the first end 8 of the tube 4 and into the user's mouth. The first passageway 12 may be of any diameter which will permit a sufficient amount of first filter medium 22 and second filter medium 24 (as described hereafter) to be positioned in the first passageway 12 and permit the flow of the solution from the second end 10 of the tube 4 to the first end 8 of the tube 4 while in operation. In a preferred embodiment, a first passageway 12 diameter of about 8 mm in a 10 mm tube has been found to be sufficient.

The tube 4 may be constructed from any suitable material which can be exposed to an aqueous solution and be safe for human consumption. The tube 4 is preferably constructed from a durable material capable of retaining and not substantially interacting with the filter medium as defined hereafter. Acceptable materials for constructing the tube 4 are glass, acrylic, polycarbonate, polyethylene, polypropylene, nylon, acrylonitrile butadiene styrene (ABS) plastic, polyvinyl chloride (PVC) and styrene.

A preferred embodiment of the present invention is a seven inch, linear, opaque acrylic tube with a 10 mm diameter having a first passageway diameter of about 8 mm.

Straw 2 includes a mouthpiece 26 having a first end 28 and a second end 30 with a second passageway 32 therethrough. The second end 30 of the mouthpiece 26 is sized to telescope over and frictionally fit on the first end 8 of the tube 4 as shown in FIG. 2. The first end 28 of the mouthpiece 26 preferably tapers inward to more comfortably fit in the user's mouth. As shown in FIG. 1 the tapering of the mouthpiece 26 begins at a taper point 34. The distance between the second end 30 of the mouthpiece 26 and the taper point 34 is sufficient for the mouthpiece 26 to frictionally fit over and be supported by the first end 8 of the tube 4. The mouthpiece 26 may be permanently attached to the tube 4 or fit snugly enough to remain thereon unless manually removed. Alternatively, the mouthpiece 26 may be formed as a part of the tube 4.

The second passageway 32 is sized sufficiently to receive the solution from the first passageway 12 of the tube 4 without significantly impeding the flow thereof. Preferably the diameter of the second end 30 of the mouthpiece 26 is only slightly larger than the diameter of the tube 4 with the first end 28 of the mouthpiece 26 tapering slightly inward therefrom.

The mouthpiece is constructed from a material which is durable and safely compatible with aqueous solutions for human consumption, and preferably slightly flexible in order to fit more snugly over the tube 4 and be more comfortable in the mouth. In the first preferred embodiment, the distance from the first end 28 of the mouthpiece 26 to the second end 30 of the mouthpiece 26 is about 3.75 cm, with a distance from the second end 30 to the taper point 34 of 1 cm.; the diameter of the second end 30 is 12 mm; the diameter of the second passageway 32 of the second end 30 is 9 mm; and the diameter of the second passageway 32 of the first end 28 is 5 mm at its longest point.

As shown in FIGS. 2 and 3, the present invention also includes the first plug 16, the second plug 18 and the third plug 20. Plugs 16, 18 and 20 respectively have an upper surface 36, 38, and 40, a lower surface 42, 44 and 46, and an outer periphery 48, 50, and 52.

The plugs 16 and 18 function to keep the first filter medium 22, as defined hereafter, in a selected area of the first passageway 12 of the tube 4 but permit the passage of the solution therethrough. The plugs 18 and 20 function to keep the second filter medium 24, as defined hereafter, in a selected area of the first passageway 12 of the tube 4 but permit the passage of the solution therethrough. The plugs 16, 18 and 20 may be constructed from any material or be of any size which performs the intended function as previously described and is safely compatible with an aqueous solution for human consumption. The plugs 16, 18 and 20 preferably utilize a micro filter open celled thermoplastic material comprising polyolefin plastics such as polyethylene and polypropylene.

The plugs may be secured in the first passageway 12 in any manner. Preferably the plugs 16, 18 and 20 are constructed from polyolefin plastics and are forced into the first passageway 12 and lodged therein. In a preferred embodiment using the polyolefin plastics previously described, the plugs 16, 18 and 20 are slightly larger than the diameter of the first passageway 12, and are 2-10 mm thick from the upper surfaces 36, 38 and 40 to the lower surfaces 42, 44, and 46 respectively. Preferably the plugs 16 and 20 are positioned in the first passageway 12 respectively near the first end 8 of the tube 4 and the second end 10 of the tube 4 as shown in the drawings. This leaves a maximum selected area for the first filter medium 22 and second filter medium 24 to interact with the solution. Plug 18 may be positioned at any point in the tube 4 depending upon how much of the respective first filter medium 22 and second filter medium 24 is used.

In a preferred embodiment the first plug 16 is a standard micro-filter plug; the second plug 18 may be a standard or carbon plug which may or may not be impregnated with silver; and the third plug 20 may be a standard or carbon plug and may contain a bactericidal, virucidal and fungicidal material. It will be understood that various combinations of plugs could be used in various locations in the tube.

The first filter medium 22 is disposed in the first passageway 12 between the plugs 16 and 18. The first filter medium 22 is capable of permitting the passage of the solution through the first passageway 12 while reducing the amount of impurities in the solution.

There are several factors which will affect the amount of reduction of certain impurities in the solution, some of which are the quantity and rate of the solution passing though the filter medium, the quantity of the filter medium, the surface area of the filter medium, the particulate size of the filter medium, and type of impurities in the solution.

In a preferred embodiment, the first filter medium 22 comprises granular activated carbon (GAC) and/or bone char to deodorize and absorb impurities, especially organic matter including nitrates and fluoride. Preferably, the carbon is acid washed to remove acid soluable ash from the carbon. The addition of bone char has been found to be particularly effective because it reduces fluoride.

In a preferred embodiment, the second filter medium 24 is preferably in the form of fine metal strands formed into a batting. Such strands may be spun or woven from high purity zinc and copper alloy. The strands preferably have a small diameter in the range of that of strands used in steel wool. The diameter of the strands is not critical. Preferred diameters are in the range of 0.001 to 0.003 inch. Use of the second filter medium 24 in the form of a metal strand has the advantage of increasing the surface area of metal in contact with the fluid.

The alloy consists of two dissimilar metals, copper and zinc, that once wet, create an electrostatic charge that attracts contaminants and electroplates them onto the media through a process called electro-chemical oxidation reduction. This reduces such heavy metals as lead, mercury, hydrogen sulphide, aluminum, arsenic, cadmium, chromium, and barium, in addition to chlorine, fluoride, E. coli, giardia, algae, fungus, scale, sediment, and pseudomonas. This electro-chemical oxidation reduction process is scientifically proven to effectively reduce contaminants.

In operation, the second end 10 of the tube 4 is placed in an aqueous solution (water). The aqueous solution is drawn into the straw by sucking on the first end 8 of the tube 4 or the first end 28 of the mouthpiece 26.

Tube 4 is a thin-walled cylindrical tube of plastic material, preferably ABS plastic, having a wall thickness in the range of about 0.2 to 0.02 inches, more preferably about 0.025 inches. ABS is strong and thus permits a thin yet relatively rigid wall. Provision of a thin wall is useful so as to maximize the diameter of the internal passageway 12 through the tube yet keeping the outside diameter of the tube sufficiently small to approximate that of a normal straw and permit use with sport and hospital type water bottles and other containers having small openings for straws. Providing the tube to be of a thin-walled material is advantageous to maximize the passage size which reduces the suction pressure necessary to efficiently draw water through the straw. The ABS should be food grade as, for example, U.S. FDA approved.

ABS plastic also has the advantage of being electroplatable so the tube can be provided with a thin, electroplated decorative metal layer over the exterior of the tube.

Plugs 16, 18 and 20 comprise a micro filter through which small particles cannot pass. The plugs are of an open-celled thermoplastic material selected to have pore openings sufficiently small to physically filter suspended particles. Preferably, the plugs comprise polyolefin plastics such as polyethylene and polypropylene which are sintered so as to provide an open cell pore structure.

Plugs are molded to form a circular disc which is 2 mm to 10 mm in depth. A plunger can be used to insert the plug into the tube to a desired distance from the end of the tube. This has greatly simplified the process because it is no longer necessary to pre-heat the plugs to compress them and insert them into the tube before allowing them to cool. This has resulted in cost savings.

The second embodiment filters out suspended particles via means of each of the three plugs 16, 18 and 20. Second filter medium 24 filters out chlorine, lead, mercury, aluminum, arsenic, cadmium, chromium, barium, hydrogen, sulphine and other impurities such as algae, fungus, scale and sediment.

To reduce fluoride, bone char may be added to the first filter medium 22. In addition or as an alternative to bone char to reduce fluoride, a layer of Al₂O₃ (aluminium oxide) may be provided below the third plug 20. For example, a fourth plug may be provided and the Al₂O₃ could be disposed as a powder between the third plug and the fourth plug below the second filtered medium 24. Any Al₂O₃ which may pass through the third plug 20 would be filtered out by the second filter medium 24. Rather than provide a fourth plug, a preferred method of incorporating granular material or powder in the tube in small amounts is to incorporate the granular material or powder into at least any one of the first plug 16, the second plug 18 and/or the third plug 20 at the time it is being formed. Up to about 2% preferably 5% by volume of the plastic plug can comprise a granular and/or powdered material which is ingrained within the opened cell during its formation and is substantially trapped therein against removal. Thus, a sprinkling of Al₂O₃ powder may be provided in at least any one of the first plug 16, second plug 18 or the third plug 20 captured in the plug and thus serve the function of additionally removing fluoride from any fluid.

The straw is particularly adapted to filter out chlorine and metals from treated water such as available from taps in cities in North America. However, the straw is useful to treat almost any water which contains chlorine, such as untreated water to which chlorine tablets have been added for treatment.

It has also been found that a larger straw can be advantageous when the user desires to draw more water through the tube.

The scope of the claims should not be limited by the preferred embodiments set forth in the examples, but should be given the broadest interpretation consistent with the description as a whole.

### LIST OF ELEMENTS

2 drinking straw
4 tube
6 outer periphery
8 first end
10 second end
12 first passageway
14 interior wall
16 first plug
18 second plug
20 third plug
22 first filter medium
24 second filter medium
26 mouthpiece
28 first end
30 second end
32 second passageway
34 taper point
35 top edge plug one
38 top edge plug two
40 top edge plug three
42 bottom edge plug one
44 bottom edge plug two
46 bottom edge plug three
48 outer periphery plug one
50 outer periphery plug two
52 outer periphery plug three

1. A drinking straw for filtering an aqueous solution containing impurities and delivering the filtered solution to a person's mouth, comprising:
a tube having a first end and a second end with a first passageway therethrough, wherein the tube is sufficiently sized so that the second end contacts the aqueous solution and the first end is receivable in the person's mouth;
filter medium disposed in the first passageway capable of permitting the passage of the solution through the first passageway while reducing the amount of impurities in the aqueous solution that passes through the tube; and
at least two plugs positioned in the first passageway such that the filter medium is retained in a selected area of the first passageway between the plugs, wherein the plugs are capable of permitting the passage of the aqueous solution through the plugs but will not permit the passage of the filter medium through the plugs,
the plugs being fixed in the passageway in a friction fit relation by the plugs having been inserted into the passageway at room temperature by the use of a plunger.

2. The drinking straw of claim 1 wherein the plugs comprise a micro filter open cell thermoplastic material having sufficiently small pores therethrough to prevent suspended solids from passing therethrough.

3. The drinking straw as claimed in claim 2 wherein
three plugs are provided at spaced locations,
a first filter medium is provided between the two plugs closest the first end, and a second filter medium is provided between the two plugs closest the second end,
the first filter medium comprises granular, activated carbon (GAC), the second filter medium comprises fine metal strands formed into a batting.

4. The straw as claimed in claim 3 wherein the carbon is acid washed to remove acid soluble ash from the carbon.

5. The straw as claimed in claim 3 wherein the first filter medium also includes bone char.

6. The straw as claimed in claim 3 wherein said metal comprises an alloy of high purity copper and zinc.

7. The straw as claimed in claim 3 wherein the first plug is a microfilter plug comprising a polyolefin plastic such as polyethylene and polypropylene.

8. The straw as claimed in claim 3 wherein the second plug is a carbon plug.

9. The straw as claimed in claim 3 wherein the second plug is a carbon plug impregnated with silver.

10. The straw as claimed in claim 3 wherein the third plug is made with bactericidal, virucidal and fungicidal material.

11. The straw as claimed in claim 1 wherein the tube is a seven inch linear, opaque acrylic tube with a 10 mm diameter having a first passageway diameter of 8 mm.

12. A straw as claimed in claim 1 further including active A102 for removal of fluorine ions from the aqueous solution, said A102 retained within the plug closest the second end by impregnating the plug with up to 5% by volume A102 during manufacture of the plug.
